(19) United States
(12) Patent Application Publication
(10) Pub. No.: US 2008/0032739 A1
(43) Pub. Date: Feb. 7, 2008

(54) Management of digital media using portable wireless devices in a client-server network

(76) Inventors: Faraz Hoodbhoy, Santa Clara, CA (US); Adnan Agboatwalla, Santa Clara, CA (US); Vladimir Soskov, Milpitas, CA (US); Asad Islam, Richardson, TX (US)

Correspondence Address: DLA PIPER US LLP, 2000 UNIVERSITY AVENUE, E. PALO ALTO, CA, 94303-2248, US

(21) Appl. No.: 11/642,798

(22) Filed: Dec. 20, 2006

Related U.S. Application Data
(60) Provisional application No. 60/752,976, filed on Dec. 21, 2005.

(51) Int. Cl. H04M 1/00

(52) U.S. Cl. 455/556.2

(57) ABSTRACT

A system and method for the management of digital media using portable wireless devices in a client-server network is provided. The system includes methodologies for managing, with minimal user interaction, digital media content (such as audio, image, video, graphics, text, etc.) generated by users of portable wireless devices (such as cell phones, personal digital assistants, network-connected digital cameras, etc.). The management of media content includes processes such as content capture, pre-processing, archiving, categorizing, enhancement, browsing, transfer, sharing, publishing, printing, etc.

### PRIORITY CLAIM/RELATED APPLICATION

This applications claims priority under 35 USC 119(e) and 120 to U.S. Provisional Patent Application Ser. No. 60/752,976 filed on Dec. 21, 2005 and entitled “Digital Media Lifecycle Management System and Method” which is incorporated herein by reference.

### FIELD

The invention relates generally to a system and method for managing the lifecycle of digital media such as digital media captured by a computing device.

### BACKGROUND

In today's environment of portable wireless devices, everyone has too much digital data including email messages, digital photographs and the like and a person desirably would like to be able to manage that digital data/digital media. In the example of digital photographs captured using such devices, the typical process to manage those digital photographs is shown in FIG. 1. A user may use a mobile phone 10 equipped with a digital camera to take a picture and then save that digital picture in the memory of the mobile phone. The user, in order to enjoy/manipulate/share/print the digital photograph, must then download the digital pictures one at a time over a communications link and then delete the digital picture files from the memory of the mobile phone. The user may then take those digital pictures and make an online folder (on the user's computer or on a website) into which the digital pictures may be stored. Then, when the user would like to use/print/share/manipulate a particular digital picture, the user may access the digital picture. In particular, the step of downloading the digital pictures, one at a time, from the mobile phone to a computer is tedious.

The typical laborious and time consuming process as shown in FIG. 1 for transferring digital content from portable devices to a personal computer (where it can be widely and easily utilized) inhibits users from properly utilizing their generated content. The result is that most content generated by users using their portable devices, especially, mobile phones, never leaves the device and then it is eventually deleted without ever being shared or properly utilized.

The system and method described below overcomes such constraints inherent in existing device content management systems. The system provides a simple, efficient and comprehensive solution, with minimal user interaction, for managing the entire lifecycle of device media content—from capture, device processing, transfer, to server-side processing for various applications such as browsing, sharing, publishing, and printing.

### SUMMARY

A system and method for the management of digital media using portable wireless devices in a client-server network is provided. The system has methodologies for managing, with minimal user interaction, digital media content (such as audio, image, video, graphics, text, etc.) generated by users of portable wireless devices (such as cell phones, personal digital assistants, network-connected digital cameras, etc.). The management of media content includes processes such as content capture, pre-processing, archiving, categorizing, enhancement, browsing, transfer, sharing, publishing, printing, etc.

### BRIEF DESCRIPTION OF THE DRAWINGS

FIG. 1 illustrates a conventional digital photograph lifecycle;

FIG. 2 illustrates an example of an implementation of a digital media management system;

FIG. 3 illustrates further details of the example of the digital media management system including the clustering architecture of the system;

FIG. 4 illustrates further details of the example of the digital media management system including the server interactions of the system;

FIG. 5 illustrates further details of the example of the digital media management system including the modules of the system;

FIG. 6 illustrates further details of the example of the digital media management system including the database design of the system;

FIGS. 7 and 8 illustrate further details of the client processes of the system;

FIGS. 9 and 10 illustrate further details of the service unit processes of the system;

FIG. 11 illustrates an example of the begin application workflow of the collection application of the system;

FIG. 12 illustrates an example of the collection workflow;

FIG. 13 illustrates the media flow of the system;

FIG. 14 illustrates a settings process flow of the system;

FIGS. 15-17 show examples of the user interface for the gallery on the computing device, the web-based gallery and the WAP page gallery, respectively of the system; and

FIGS. 18A-18D illustrate examples of the advertisements provided by the system to the computing device.

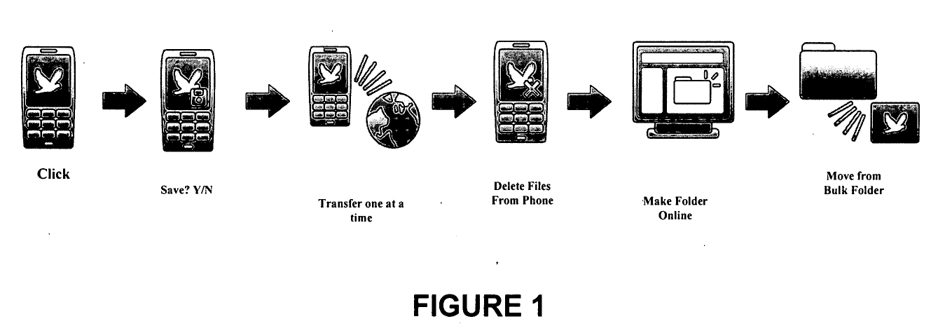

### DETAILED DESCRIPTION OF ONE OR MORE EMBODIMENTS

The invention is particularly applicable to a client/server digital photograph lifecycle management system and it is in this context the system will be described for illustration purposes. It will be appreciated, however, that the system and method has greater utility since the system and method may be used to manage other pieces of digital content such as audio, video or any other known or to be developed digital media. The illustrative system manages the digital media for a mobile phone having a digital camera, but the system may be used with various types of computing devices as described in more detail below. The implementation described below is in the context of a client-server environment where a portable wireless device (such as cell phone, personal digital assistant, a network-connected digital camera, etc.) serves as the client and the underlying content management service provider provides the server that resides in the network. However, the system can be implemented in other environments and with other client devices and the system and method is not limited to the particular environment or the client device shown below.

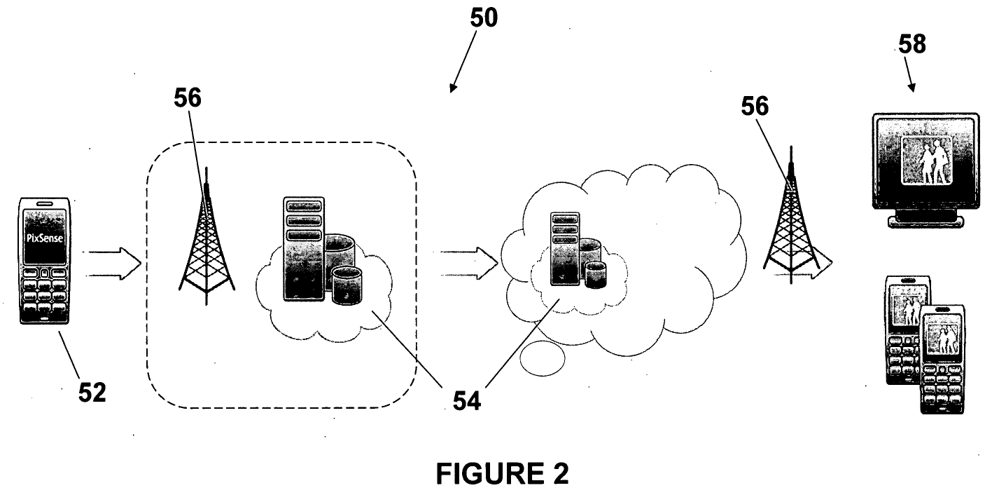

FIG. 2 illustrates an example of an implementation of a digital media management system 50. The system may include one or more computing devices 52 and a service unit 54 wherein the one or more computing devices 52 and the service unit 54 interact with each other over a link 56. The service unit may be hosted by an operator network or independently outside of it, depending on who owns the service offered by the service unit. Each computing device may be a processing unit device with sufficient memory, processing power and connectivity in order to interact with the service unit over the link. For example, each computing device may be a mobile phone device, a cellular phone device, a portable email device such as a Blackberry, a smartphone device, such as a Palm Treo or Palm operating system compatible devices or a PocketPC device, such as the HP Journada and the like. In the implementation of the system shown in FIG. 2, the computing device may be a typical portable wireless device, such as a mobile phone, which operates within the existing operator network 56 using the available wireless communication technology such as GSM/EDGE, WCDMA, CDMA 2000, etc.

As shown in FIG. 2, both embodiments of the service unit 54 are shown wherein the service unit 54 may be either part of the operator network or separate from the operator network (but utilize the network as the link 56). The network 56 may also be used to couple the service unit 54 to one or more other devices 58 that may execute an application for the collection/management/display of the digital media wherein the one or more devices may be a personal computer executing an application or a browser on which a user interface of the application is displayed or another computing device and the like. Using this service architecture, the system provides a method and system for managing the entire life cycle of user-generated device content without, or with minimal, user interaction. The various processes provided by the system may include: content capture, device processing, data compression, data transport, device management, content analysis, content categorization, content enhancement, asynchronous advertisement delivery and/or server-side content processing each of which is described in more detail below. Using these processes, the system can be used to provide content services, with minimal user interaction, for various content applications, such as: capture, organization and querying, browsing, sharing, publishing, printing and/or advertising. The result of the system is that the typical computing device enjoys various mobile services with superior quality, enhanced experience and minimal effort.

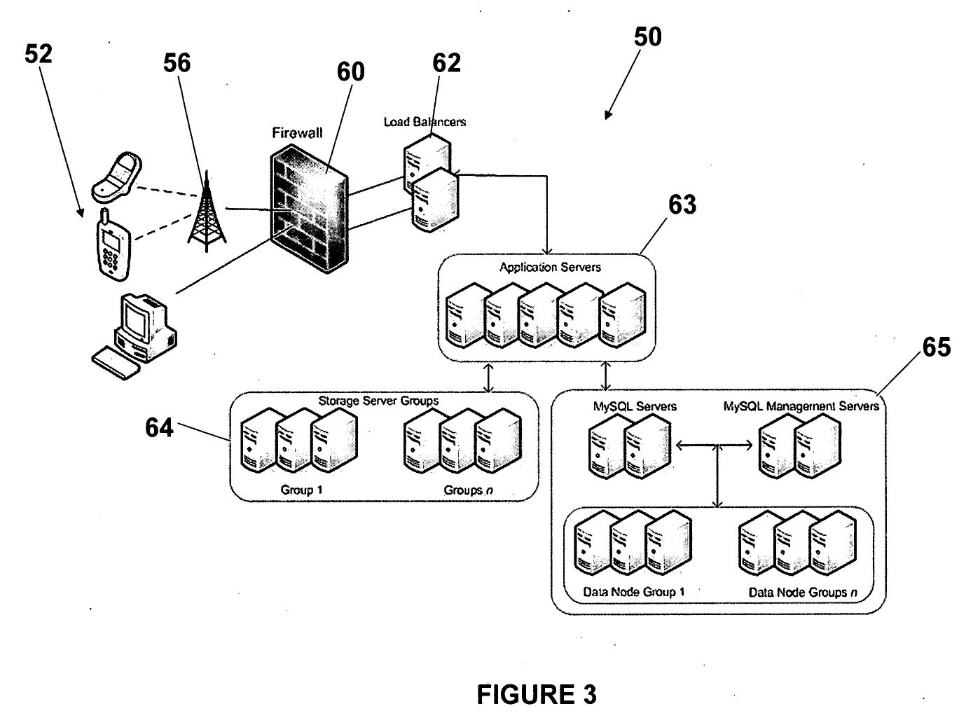

FIG. 3 illustrates further details of the example of the digital media management system including the clustering architecture of the system 50. The system may have the one or more computing devices 52 that may communicate over the link 56 with a typical firewall 60 that prevents nefarious attacks and user interactions before the data/information communicated by the one or more computing devices is sent to one or more well known load balancers 62. The load balancers 62, based on the data/information from the computing device, may distribute the data/information to one or more application servers 63, one or more storage servers groups 64 and one or more database servers 65. The one or more application servers each may run JBoss (a popular open source application server that supports Enterprise JavaBeans (EJBs) wherein, in order to run servlets and JSPs, a servlet container, such as Apache's Tomcat, is used in conjunction with JBoss) with clustering and caching enabled Java 2 Platform Enterprise Edition (J2EE) applications/modules. The one or more application servers may run Linux, JBoss AS 4.0.4, JBoss AS clusters, Load balancer, JBoss AS caching, a server unit server application, storage server clustering and backup management of Storage servers.

The one or more storage servers 64 may have one or more groups of storage servers that run Linux and keep media files. The one or more storage servers provide an index for fast retrieval/management of media files and provide storage management for optimized performance. The one or more storage servers have an application server that manage the backup of storage servers and run Squid (an open source program that caches Web and other Internet content in a Unix-based proxy server closer to the user than the content-originating site) for communication with application server through Pipes which is a communications mechanism to communicate with the application servers.

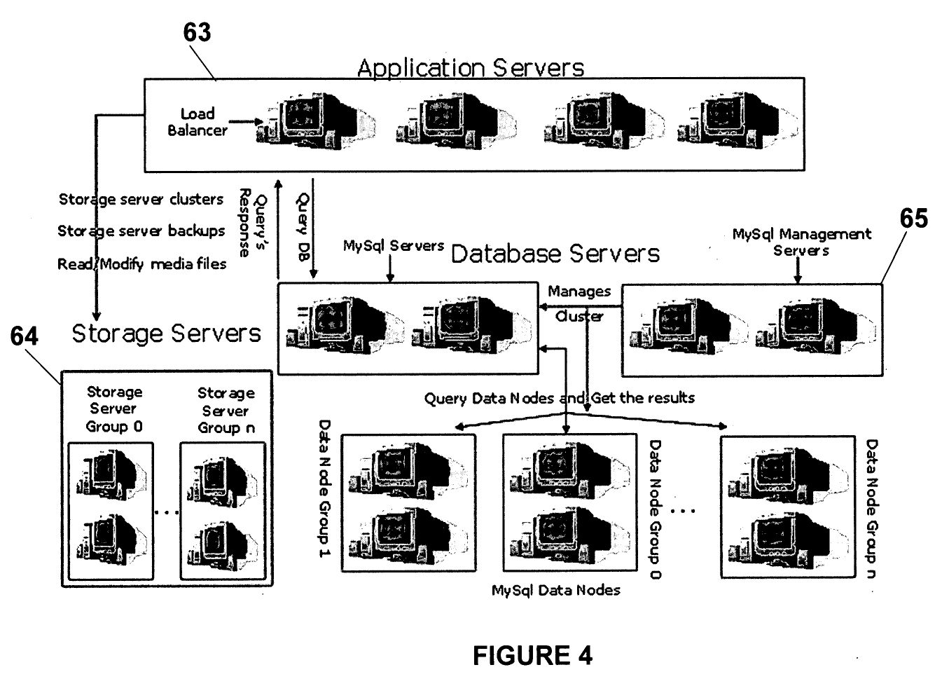

The one or more database servers 65 may further include one or more MySQL servers, one or more MySQL Management servers and one or more data nodes. The one or more database servers run Linux, run MySql 5.0 and also run MySql clusters. The one or more MySQL servers distribute and Manage MySql Data nodes and have an application server that communicates with the MySql Server which in turn communicates with MySql Data nodes to get the data. The MySql Management Server provides cluster building, logging, etc. The MySql Data Nodes run the MySql database wherein the data nodes keep records stored in the database and provide data replication on backup node. FIG. 4 illustrates further details of the example of the digital media management system including the server interactions of the system. As shown, the application servers may access the storage server clusters, perform storage server backups and read/modify media files that are stored in the storage servers. The application servers may also generate database queries to the database servers and receive query responses. The MySQL management servers may manage the clusters and also query the data nodes and get the results from the MySQL data nodes.

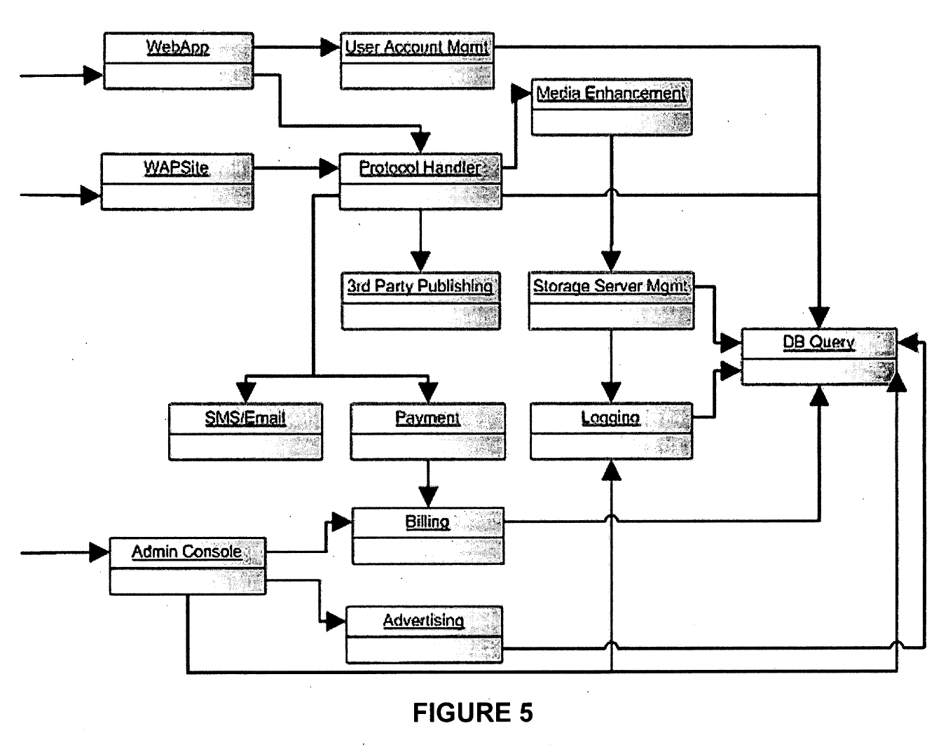

FIG. 5 illustrates further details of the example of the digital media management system including the modules of the system. The modules act as wrapper classes for the actual application, which consists of several submodules that are not shown in the figure. The modules include a WebApp module that handles the web application (the collection/gallery), a WAPSite module that handles the client WAP application (the client application on each computing device), an AdminConsole module that handles the administrator login and management, a UserAccountMgmt module that handles the user registration, account creation, account deletion, updating account information and checks the user login and a ProtocolHandler module that handles the main functionality of the system and passes control to other modules. The module further include an SMS/Email module that is responsible for sending an short message (SMS) and/or email message to each computing device upon registration and/or when other events occur, a 3^{rd} Party Publishing module that handles uploading of the media files to 3^{rd} party websites, a MediaEnhancement module that checks if the uploaded media need some enhancement, make some enhancement/changes and then saves it to the server, a StorageServerMgmt module that handles the automatic uploading of the media files to the system storage unit as soon as they become available on each computing device, a Logging module that saves all the user logs containing the login time, logout time, media uploading, deleting and updating time, selling/buying and other useful information, a Payment module that handles online payment, a Billing module that calculates and generates bills for the paid users, an Advertising module that handles the publishing of the advertisements and a DBQuery module that forms the backend of the application and interacts with the database to store and retrieve information.

In more detail, the WebAPP module may implemented using Struts 1.2 which is an open source framework for building Servlet/Java server pages (JSP) based web applications based on the “Model 2” approach, a variation of the classic Model-View-Controller (MVC) design paradigm. Under Model 2, a servlet (or equivalent) manages business logic execution, and presentation logic resides mainly in server pages. The Java Servlet API is a Standard Extension to the Java platform that provides web application developers with a simple consistent mechanism for extending the functionality of a Web server and for accessing existing business systems. The WebAPP module may include validation framework for form validation and Velocity for isolation of code and display (output HTML templates). Velocity is a Java-based template engine that permits anyone to use a simple yet powerful template language to reference objects defined in Java code. Velocity separates Java code from the web pages, making the web site more maintainable over its lifespan and providing a viable alternative to Java Server Pages (JSPs) or PHP. The WebAPP module may also include servlet filters for common tasks, Java Server Pages Standard Tag Library (JSTL) for dynamic control and JSP.

The WAPSite module may be implemented using the known Asynchronous JavaScript and XML (Ajax) for Client Site handling and the WAP Protocol. The AdminConsole may be merged with the WebApp module that may be implemented as java routine interacting with other modules. The UserAccountMgmt module may be implemented as a java routine interacting with the DBQuery Module. The ProtocolHandler module may be implemented with servlet filters for interception of requests and java routines. The SMS/Email module may use known 3rd party gateways like clickatell and bulksms. The 3^{rd} Party Publishing module may include other modules connecting to 3^{rd} Party sites. The MediaEnhancement module may be implemented as Java Routines using proprietary media enhancement processes. The StorageServerMgmt and Logging modules may include java routines. The Payment module may use 3^{rd} party services like VeriSign and may include java routines. The Billing module may include java routines interacting with DBQuery Module and the Advertising module may include a java routine. The DBQuery module may be implemented using Hibernate (a powerful, high performance object/relational persistence and query service wherein Hibernate lets you develop persistent classes following object-oriented idiom—including association, inheritance, polymorphism, composition, and collections) and may include a serialized Bean Object.

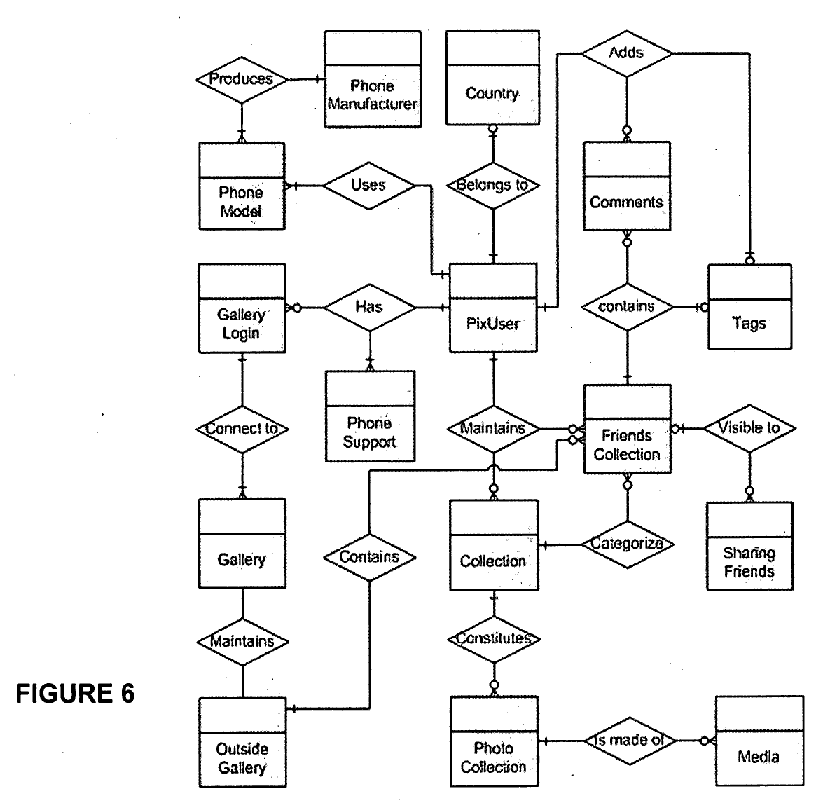

FIG. 6 illustrates further details of the example of the digital media management system including the database design of the system. As shown, the relationships between the individual components/records of the database design is shown in FIG. 6. In the example shown in FIG. 6, the components/records are stored in tables in the relational database tables although the system is not limited to this implementation of the database. Thus, in this example, the database may include a PixUser table that stores user account information for each user of the system and a PhoneModel table that stores the specifications/characteristics of each different type of computing device supported by the system wherein support for a new type of computing device can be easily provided by adding a new PhoneModel table for the new computing device. The database may further include a PhoneManufacturer table that stores manufacturer details for each computing device and a PhoneSupport table that links the PixUser table with the PhoneModel table in order to associate a computing device type with each user of the system. The database may further include a Media table that stores the media file information and a PhotoCollection table that links the Media Table with a Collection table that stores the Collection information for each user wherein the collection for each user includes the various pieces of media associated with the particular user. The database also includes a FriendsCollection table that stores the information about any shared collections, a SharingFriends table that stores the friends information for each user and a Comments table that stores the comments for each FriendsCollection. The database may also include a Tags table that stores the tags for each FriendsCollection, a Country table that stores the country details, a Gallery table that stores the gallery details, a GalleryLogin table that stores the account information to sign in the gallery and an OutsideGallery table that links the FriendsCollection with the Gallery table.

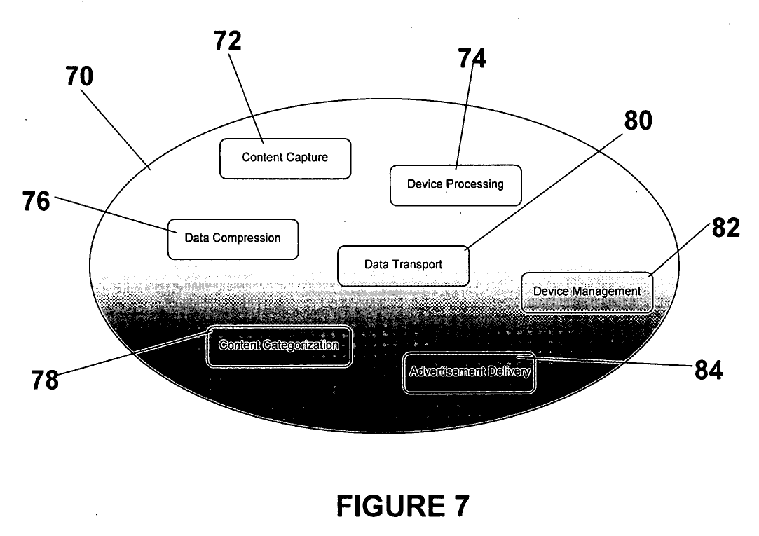

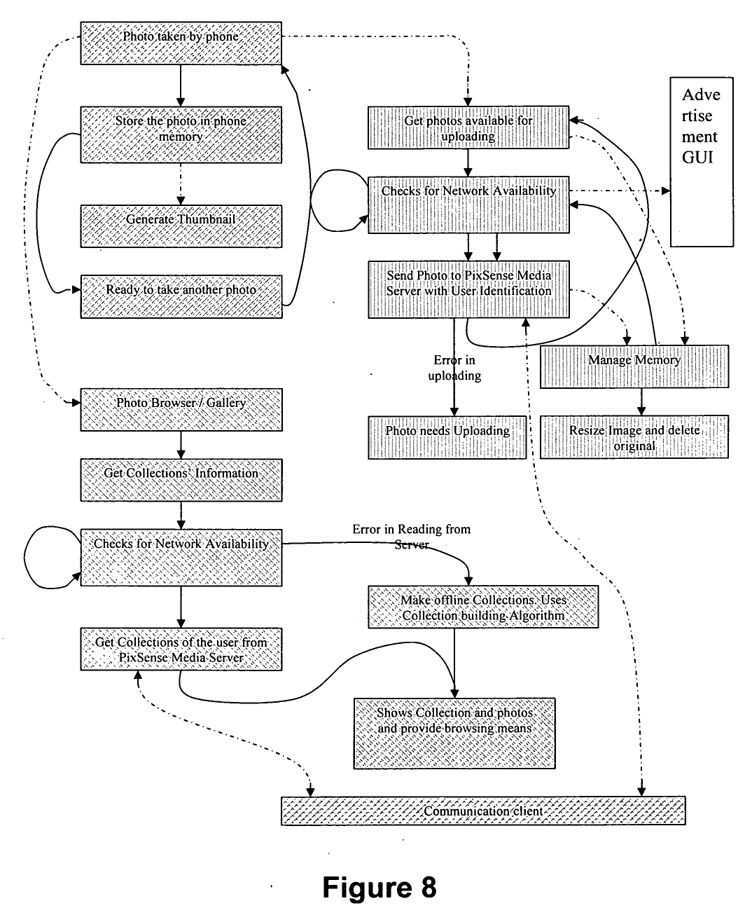

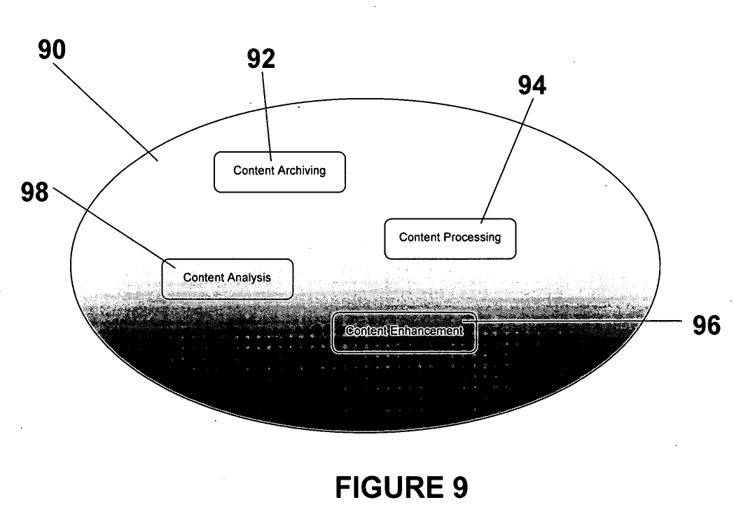

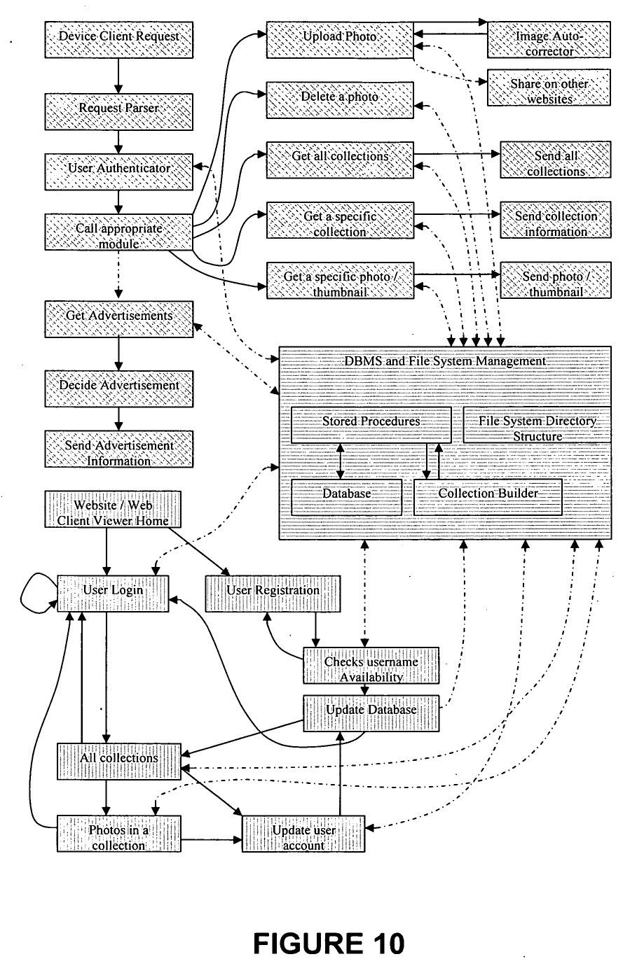

The system may include one or more client processes and modules and one or more server side processes and modules. The client processes and modules are described with reference to FIGS. 7 and 8 while the server processes and modules are described with reference to FIGS. 9 and 10. The client processes and modules are now described in more detail.

FIGS. 7 and 8 illustrate further details of the client processes and modules of the system. A client platform 70 is a framework for creating media management services on computing devices, such as mobile phones. In an exemplary implementation of the system, the client platform is implemented as one or more pieces of software code (with each piece of software code having a plurality of lines of computer code) that are executed by a processing unit that is part of the computing device. The requirements for such a framework are:
To be portable (has to run on multiple operating systems and devices)
To have relatively small footprint (i.e., very memory efficient)
To be independent of the Java 2 Platform, Micro Edition (J2ME) security restrictions and API limitations
To be very fast in execution; and
To provide flexible set of interfaces

As shown in FIG. 7, the client platform 70 may include a content capture module 72, a device processing module 74, a data compression module 76, a content categorization module 78, a data transport module 80, a device management module 82 and an advertisement delivery module 84. FIG. 8 illustrates the steps of a digital media lifecycle management process implemented by the modules shown in FIG. 7.

Content Capture Module

The content capturing module is resident on the computing device and provides an interface for an application to interact with the capturing device. The capturing module also generates metadata that can be associated with each media file wherein the metadata may include information such as the time, data and if location based services are available, the location where the content was captured. In the case of visual data, the capturing device is the digital camera resident on the computing device. The content capturing module may be a piece of custom software that differs from an already present camera application because the content capturing module removes any extra features that are unnecessary for this solution and/or complicates the user interface, provides single click snapping operation and provides a way to go to the photo gallery to view already taken photos. The system may also be implemented with the native capturing device application as long as the native capturing device application provides the necessary features outlined above.

Device Processing Module

This module is resident on the computing device and performs some important processes with low-complexity for manipulating the captured content. For example, for image data, the module provides intelligent thumbnail generation, image rescaling to fit screen size, image rotation, JPEG conversion and others. For video data, thumbnails are intelligently generated by picking out the first “visually legible” frame from the video. For audio data, a 3 second footprint is saved as its “thumbnail”. The device processing module is extremely memory and CPU efficient, and uses optimized algorithms for such processes.

Video Thumbnail Generation

Typically, first frames of a video are used as thumbnail representations of the video. The first frame, however, may not be a meaningful frame. When a user starts capturing video, the camera sometimes takes a while to adjust to the brightness level of the capture. This may result in over- or under-exposed first few frames, so that visually they are not meaningful enough. Likewise, for an edited video, the first frame may be black or have some text which doesn't show in thumbnails. One solution to this problem is to visually detect the first visually good frame that has meaningful information.

The process for intelligent thumbnail generation from a video sequence looks at each frame of the video starting from the first frame. It tests the frame for two conditions:
a) The pixel intensity variation in the entire frame must be greater than a certain threshold.
b) The standard deviation of the pixel intensities must be sufficiently large.
   The values of the two thresholds in the above conditions is subject to change and is determined by experimentation. If a frame passes these two conditions, it means that the frame is visually meaningful and is chosen as the frame for the video's thumbnail. The algorithm is stopped thereafter.

Audio Thumbnail Generation

A similar approach works for audio data. Audio is analyzed for about 3 sec. after every arbitrary instance of time (say 1 sec.) starting from the beginning. If there is sufficiently enough variation in the audio segment, then the segment is taken as an audio thumbnail for the audio.

Likewise, for image resizing, rescaling, etc., care is taken to use simple and fast algorithms with least computational complexity. This ensures less overhead for device processing, fast execution times and better user experience.

The module is used by the underlying application running in the background without disturbing the work in the rest of the system.

Data Compression Module

This module is an important component of the client platform. The module reduces the file size of the captured content without compromising its perceptual quality. The advantages are tremendous in terms of bandwidth and storage. The content, which is eventually transmitted through the network, has a lower data size, which helps to reduce the cost of data transmission for the user as well as to reduce network data traffic for the operator. On the server side, the decreased data size helps reduce storage costs. The data compression module is extremely memory and CPU efficient. An example of a data compression system and process used by this module is the system and method for efficient compression that is described in the co-owned, co-pending patent application Ser. No. ______, filed on Dec. ___, 2006 with the title “Efficient content compression and decompression system and method” which is incorporated herein by reference. This module is used by the underlying application running in the background without disturbing the work in the rest of the system.

Content Categorization Module

The content categorization module may permit the user of the computing device to categorize the content/media or may automatically perform content/media categorization. Categorization helps in collection building wherein collections (e.g. content albums) are groups of content instances (e.g., images) that are logically associated with each other. The captured content can be categorized according to some arbitrary associations and grouped together into different collections for quick and easy content organization. The categorization may be based on: time and date intervals, location, user tags and/or a combination of the time and date interval, location and user tags. The time and date intervals can be any of the following types: 1) Fixed: Collections are made using a fixed time interval, such as for example pictures taken within a one hour period; and 2) Event Based: Collections are built by analyzing the time intervals that occur between content capture so that, for example, pictures taken within a short time interval can be grouped together to form a collection and those with larger time intervals can be put into separate collections.

The location categorization may be the location where the content was captured which can be obtained, for example, via the wireless carrier APIs dealing with geographic location of the device. In the system, each instance of the content (image) can be tagged with a location and collections can be created based on the proximity of the location where the content was captured.

In the system, users are able to tag images and collections can be built based on tag information so that, for example, a collection called “birthday” holds all the pictures with the tag “birthday”. The collections can be built using a combination of the above categorization criteria so that, for example, a collection may have content/media of a “birthday” at a particular location.

Data Transport Module

This module is responsible for efficiently transporting data from the device to the service unit (a server in an exemplary implementation) via the link. The transfer of captured content is done in an intelligent manner by making use of several indicators and monitors. Most importantly, the transfer takes place in the background without any interaction with the user. The Data Transport module handles different processes for managing the captured content in an efficient manner that include transport, packetization and advertisement delivery.

Transport Process

The Data Transport module handles the scheduling and transfer of media files between the computing device and the service unit. The module employs user's information stored on the computing device to let the service unit identify the user. The module may include a scheduler, a transfer handler and a storage manager.

The scheduler and storage manager use sophisticated algorithms and a set of monitors (a file system monitor, a device monitor and a media access monitor) to schedule the media transfer and free storage space on the computing device. The file system monitor monitors the file system utilization and triggers events on the scheduler when the amount of free storage space reaches a certain threshold or decreases too fast. A network monitor gathers and provides statistics for the network bandwidth and availability in time and space. The device monitor gathers and provides statistics about the way the device has been used (up time, application usage, etc.) and the media access monitor provides information about the last time a media file has been accessed by user and the frequency with which this file is used by the user.

When an instance of content (e.g., image) is transferred to the service unit, the instance (image) is deleted from the computing device to save storage space. However, a footprint (screen size thumbnail) is left on the computing device and is available for playing (viewing) while the computing device is offline. The storage manager can make a decision to remove that footprint (thumbnail) from the computing device based on input from the monitors. The original content (image) will still be available when the computing device is online, and can always be downloaded back from the service unit if there is ever a need to do so.

The transfer handler moves media files, metadata and other information between the service unit and the computing device. The transfer is asynchronous, is very memory efficient, and works in the background. It neither affects the other applications running on the system nor does it interfere with the phone calls. The transfer handler handles network drops gracefully by retaining state information and automatically resuming the interrupted operation when the network is available.

Packetization

The data transport module is also responsible for intelligently packetizing the data before transmitting it. The process involves breaking the data into arbitrary packets with appropriate headers. The advantage becomes apparent when transferring large files, such as high resolution images or video files.

If the network drops in the middle of the file transfer, the data transport module does not re-send the part of data that has already been successfully received by the service unit. Instead, it only sends the data that has not been received by the service unit. Proper communications protocol between the computing device and the service unit are used to ensure that correct state information is always present between computing device and service unit, so that content is always transported in the most efficient manner.

Advertisement Delivery

The data transport module is integrated with the Advertisement Delivery Engine and handles advertisements either pushed by the service unit or pulls requested by the computing device. By using the data transport module, applications residing on the computing device that is connected to the network give the user the experience of browsing those images locally on the computing device. The module provides thumbnails for the images first and then the full images, if requested. This provides a unique experience to the user so that they perceive that they have unlimited storage space.

Device Management Module

The device management module implements various subtle but high-value computing device management processes. These processes add value to the user experience, enhance the existing technology, and optimize the underlying platform constraints in order to extract the best possible results.

The Device Management module activates a background application that continues to run as long as the computing device is switched on. The main purpose of this application is to monitor the entire content management process on the device and keep it optimized. The application organizes the content on the computing device and uploads the content data to the service unit. In case there is no network connection available, it takes care of uploading the content according to the schedule and connection availability. The Device Management module is responsible for many different processes performed at the device including synchronization, memory management, auto-updates and a watchdog process.

Synchronization

The device management application is also responsible for content synchronization between the computing device and the service unit. This allows the client platform to keep all the content (e.g., images) and content metadata to be synchronized between the computing device and the service unit. The synchronization API allows content file (s), meta data associated with the content (time, date, location, user tags and other metadata), one or more events (deleting content, deleting collections of content, sharing content with public, making content private and/or sharing content with other private users), and logs for user behavior (number of instances of content captured, number of times the user went from content capture to content playing, number of times the user went from the menu to content playing, number of times the content collection was played in the gallery, number of times the content footprint was played in the gallery, number of times the content was played in the gallery and so on) to be synchronized.

Memory Management

The synchronization described above is one way for the application to perform automatic memory management on the computing device. As the data files are transported to the service unit, the content is removed from the device making room for the next set of content that allows the user to have virtually unlimited storage on the computing device. The memory on the computing device is managed by detecting one or more of the total memory available, the total memory used by the application, the amount of content captured, the date and time of content captured and/or the date and time of content successfully transferred to service unit. To manage the memory of the computing device, the platform may generate a reduced footprint of the original content and delete the original and detect the age of the content, and then delete it accordingly.

Auto-Updates

The device management application is also used for triggering automatic updates by downloading and installing client software updates on the computing device. The updater downloads and verifies the integrity of the patch, shuts down the rest of the application, backs up everything affected by the patch and applies the patch. If the patching was not successful, it restores the application in its previous state. The entire process is done automatically and provisioned over the air without user intervention.

Watchdog

Integrated with the device management application is a watchdog application that also runs in the background. It is a small application that is not supposed to crash at all. Its job is to keep an eye on the device management application. In case the device management application crashes or is somehow closed, its responsibility is to launch it again, as there is no other way to launch it again. Watchdog application must be started automatically whenever the computing device is switched on and should keep itself running unless the mobile phone is switched off.

Advertisement Delivery Module

The advertisement delivery module facilitates the asynchronous advertisement delivery to the computing device. The asynchronous nature of the delivery ensures that the advertisement is delivered even in case of a network outage since the advertisements may be cached in the computing device (within the advertisement delivery module) as an invisible background process during network connectivity and delivered asynchronously to the user irrespective of the presence of a network connection. The advertisement delivery module may maintain a record of the advertisements the user is interested in and the record is transferred to the service unit and is used by the service unit to target later delivered advertisements to the user.

The advertisement delivery module may deliver an advertisement and then permit the user to interact with the advertisement. During the advertisement delivery, the module may target the customer based on his profile and display image, audio, text, graphics and video advertisements. The user may then interact with the advertisements in different manners depending on the type of advertisement. For example, the type of advertisement may cause the user to open a browser session with URL specific for the advertisement, causer the user to initiate a phone call, present the user with directions to a place related to advertisement and/or display a bar code coupon that can be read by the bar code reader in the place where the user is making a purchase.

The client platform may also include a content viewer application that is a GUI based application that can be used to browse the content collections and content in individual collections. The viewer application provides both offline and online photo browsing. The viewer application may provide a way to browse the collections of the computing device, to browse the individual content in the collections, to show thumbnail images while viewing all collections or all photos in a collection, to show Screen size and full size photos on selection of individual collection, to provide a way to delete a photo, to provide a way to browse photos on the computing device only if no network accessibility to the server is available and, during offline viewing, to provide dynamic collection building.

FIGS. 9 and 10 illustrate further details of the service unit processes of the system. A service unit platform 90 is a framework for creating media management services on one or more computing devices, such as servers, residing in the network. In an exemplary implementation of the system, the service unit platform is implemented as one or more pieces of software code (with each piece of software code having a plurality of lines of computer code) that are executed by a processing unit that is part of a server computer that hosts the service unit components of the system. The requirements for such a framework are:
To be very fast in execution
To have fast data retrieval system
To provide flexible set of interfaces

As shown in FIG. 9, the service unit platform may include one or more modules that may include a content archiving module 92, a content processing module 94, a content enhancement module 96 and a content analysis module 98. The steps of these modules are shown in FIG. 10. The service unit may also have a communications module (not shown in FIG. 9) that receives the pieces of media from each computing device.

Content Archiving Module

This module is responsible for storing content media on the service unit and archiving for backup. The storage and archival system (that is part of the content archiving module) may perform backup (archiving) of all the user data on a fixed time basis (daily, weekly, etc.), provide an optimized file storage system to allow the storage and retrieval of files or file fragments, provide a fast retrieval system that fetches the required files or file fragments without any processing overheads, provide unlimited storage to all the users of the system and generate proper keywords associated with the content that result from metadata, tagging, etc., which help in content querying from the vast collection of archives.

Content Processing Module

This module is responsible for performing various processes on the stored content. The content stored on the service unit sometimes needs to be processed in a certain manner to make it suitable for further use. There are many different processes that can be required, depending on the usage scenario. Such processes are typically done at the service unit side and include transcoding, content manipulation and copyright protection.

Transcoding

The content uploaded to the service unit is usually in the standard format in which it was captured. For example, most images are captured in the standard JPEG format and are uploaded as JPEG images. However, when the stored content is streamed back to another client, the receiving client may require it in a different format. For example, images captured in the JPEG2000 format may need to be streamed to other clients in JPEG format. As another example, video captured in one format (such as H.263) may need to be streamed in another format (such as MPEG-4). In such cases, the content needs to be transcoded, i.e., converted from one format to another. This type of processing is typically done on the service unit.

Content Manipulation

Instead of changing the format of the content (transcoding), it is sometimes necessary to manipulate the content to make it more suitable for streaming to the clients. For example, high resolution images need to be rescaled to lower resolution before they are transmitted to small screen computing device. Similar processing may be required for videos. Such content manipulation is done on the fly at the service unit.

Copyright Protection

Content uploaded on the servers needs to be protected from potential copyright infringements when it is shared with other clients. Embedding of secure digital signatures inside the uploaded content is done at the service unit to ensure copyright protection. The digital signatures may include one or more of digital watermarks, visual logo insertion, metadata insertion, etc.

Content Enhancement Module

This module is responsible for enhancing the perceptual quality of the content. Content captured from the computing devices is usually not of the highest quality so special processes are applied to improve the perceptual quality of the content from the perspective of the human user.

For example, for images or video, the following processes may be applied:

Enhancement of images
   Brightness and contrast adjustment
   Color balance
   Noise reduction
   De-blurring
   Red-eye removal
   Jitter removal
Optimization for photo printing
Using device profiles containing camera information (CMOS/CCD photo sensitivities, aperture sizes, color balances) for enhancements
User picture metadata for enhancement (time of picture taken, tags, rotation/picture orientation, outdoor/indoor lighting, etc.)
Supervised learning algorithm for auto-quality enhancement. Using human training against large variety of sample images to determine which algorithms improve quality the most.

Content Analysis Module

This module is responsible for analyzing the captured content for content understanding and metadata generation. The content uploaded on the servers is automatically analyzed to understand the semantics of the content. For example, images are analyzed to look for the presence of certain features in them, such as people, landscape, outdoor/indoor scene, etc. Objects are identified and classified according to certain features, such as shape, size, color, orientation, etc. From such visual semantics, a classification mechanism is derived where images are classified according to these different features. This process is useful in supplementing automatic categorization, organization, and querying of content.

The service unit may also include a database management and file system in which all of the user, content and collection information will reside. The content will be physically present on the file system. In addition, the file system directory management will be independent of the collections i.e. there will be no relation between the photo directories maintained on the file system and the collection information of photos in the database. Then, collections will be maintained in the database and content URL will be mapped accordingly with them. The database and file system will be distributed on more than one server for load balancing and data safety.

The combination of the service unit modules and the client platform modules provides high value, minimal user interaction services for various applications that may include content capture, content organization and querying, content browsing, content sharing, content publishing, content printing and advertising.

Content Capture Application

The system described above turns a typical computing device with a content capturing device into a highly user-friendly content capturing device with unlimited storage. Thus, instead of the many painful steps that the user needs to take to manage content, the user now has a one-click solution to capture all the content that he wishes to capture with the rest of the content management work, including storage, archiving, transfer, categorization, collection, enhancement, analysis, and memory management, being taken care of by the system. The system thus lets the user focus on capturing content.

Content Organization and Querying Application

The system provides automatic means for efficiently organizing content captured by the user. The system's analysis, categorization and collection building processes are used to build the necessary framework for ordering and collecting the content according to different criteria. This framework is also used for efficient querying of content.

The system provides content organizational capabilities without any input from the user since the content is automatically analyzed and categorized into different groups. A user interface lets the user choose to organize the content into folders, edit the metadata and create categories. All the metadata associated with the content is stored into a database on the service unit. In addition, the user is able to query content based on (a combination of) arbitrary criteria, or based on user defined tags.

Content Browsing Application

The system allows enhanced experience in browsing of captured content. In particular, a GUI based application is used to browse the content collections as a group and individual content instances within a collection. The application provides both offline and online content browsing. The content browsing may include browsing content stored on the service unit if the network is available, browsing content stored on the computing device even if network is available, browsing content on the computing device if the network is unavailable, browsing collections, browsing all the content within collections, showing content footprints (e.g., image thumbnails) while viewing all collections or all the content in a collection and/or browsing collections built with different criteria.

Content Sharing Application

The system provides content sharing with a versatile and user-friendly way for sharing user's contents with virtually any user connected to the network. Using the system, content can be shared by any user with any other user who is connected to the network and the sharing may be private sharing (content is not shared with anyone and only the user has access to it via a secure login), public sharing (content can be viewed by any user and the content is not protected by a login and is available via a public URL or within the browsing application on the device) and shared with users in which content can be specifically shared with other users on the system and the other users will have to login in order to view the content shared by the user, or view it within the browsing application on the device.

The content sharing can be initiated in three ways. First, if the end user has access to the web (via PC or device), the user can share the content through the web gallery provided by the underlying service. Second, if the end device user has the same browsing application, he can share it via the URL. Otherwise, the end device user can share the content via the WAP gallery (the GUI shown to the user on the computing device).

Content Publishing Application

The system also permits a user to push the content to third party sites. The publishing of the content may include publishing of content to internal and external applications and destinations and import and export of content to and from the device platform. The publishing application may also include verified destination delivery, online albums (private, semi-private, public), uploads to pre-defined external services (Flickr, SmugMug), sharing from the computing device (Mobile-mobile, mobile-PC) via a message (MMS, email, or SMS), upload to blogging sites and uploading to printing services.

Content Printing Application

The system may also be used to export the content to removable media or external resource. For example, images can be burnt on CD or printed on photo printers. This process may be initiated directly from the computing device.

Advertising Application

The system may also provide advertisements to each computing device and provide asynchronous advertisement delivery to the computing device. The advertisements can be based on image, audio, text, graphics or video or any combination. When a user is interested in a particular advertisement, he can click on it, as a result of which he is presented with more details about the offer and the offer may include: opening a browser session with URL specific for the advertisement, initiating a phone call, presenting the user with directions to a place related to advertisement; or displaying a bar code coupon that can be read by the bar code reader in the place where the user is making a purchase. The system may keep a record of the advertisements the user is interested in. This record is transferred to the service unit and is used later by the system to target advertisements to the user.

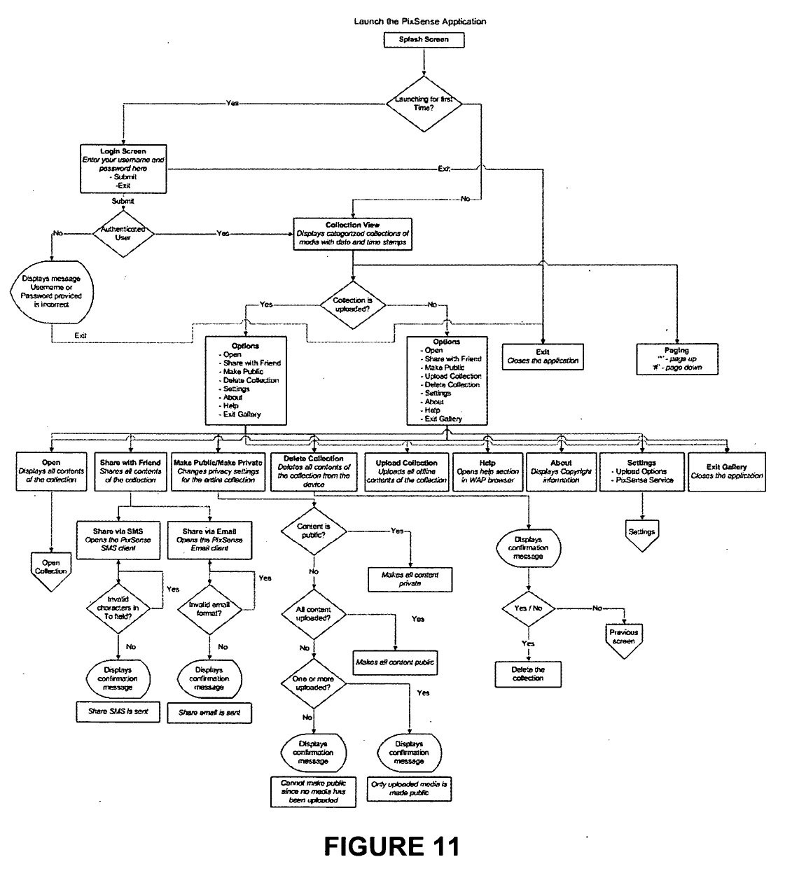

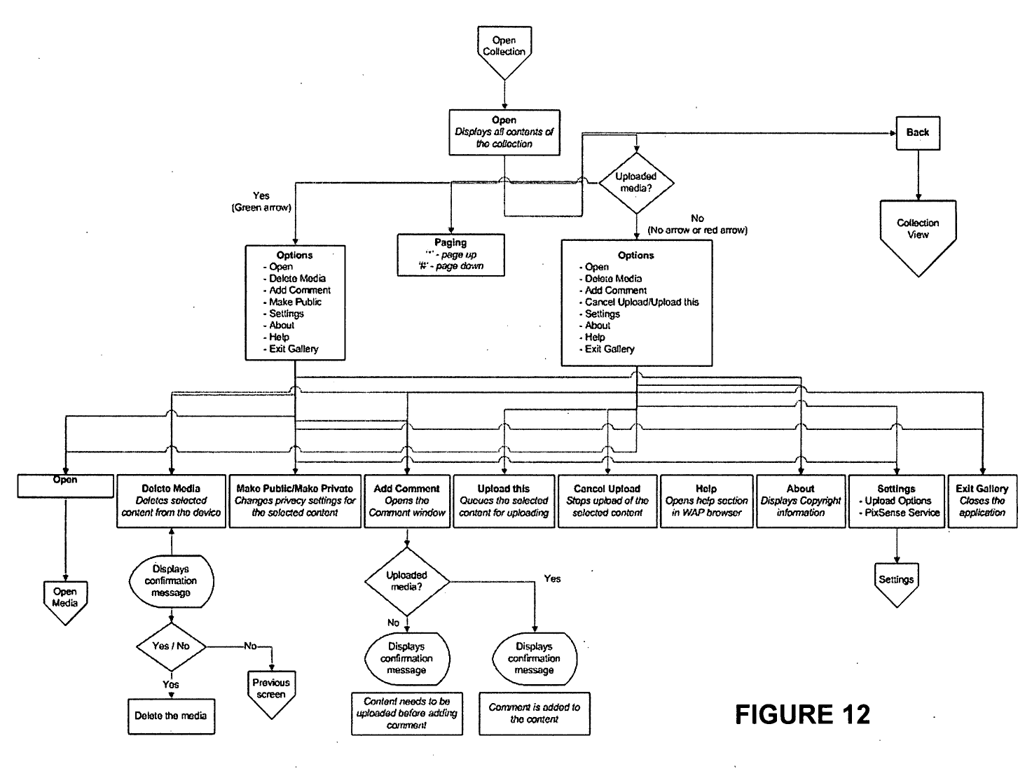

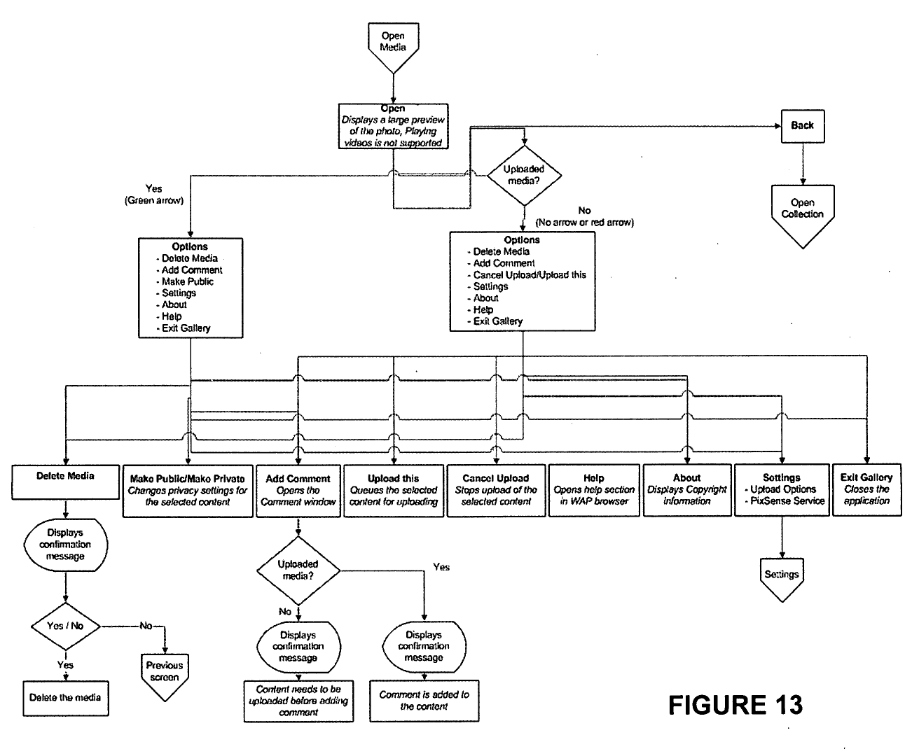

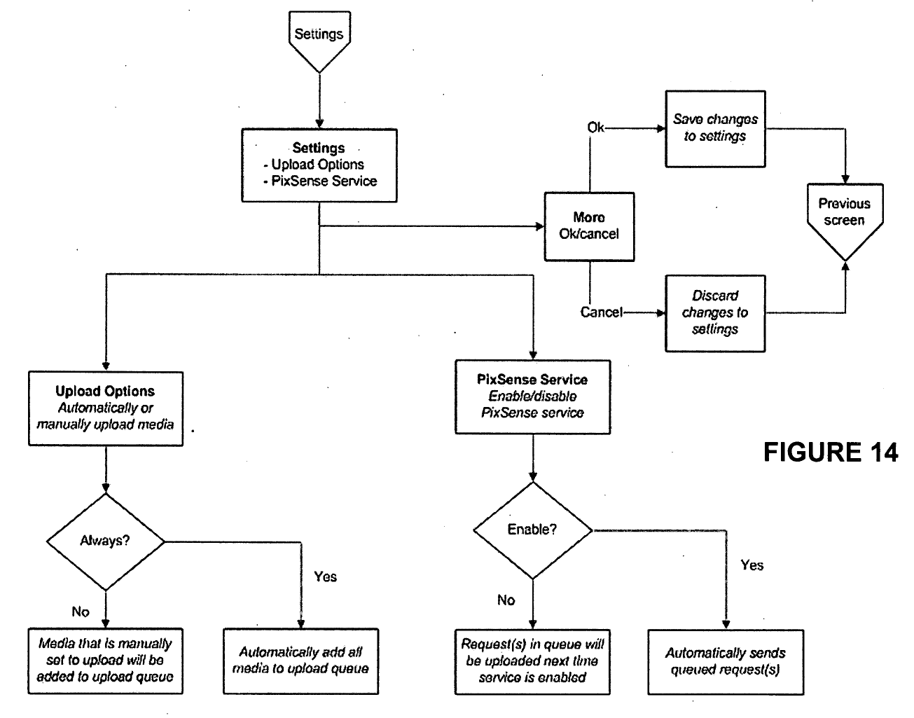

FIG. 11 illustrates an example of the begin application workflow of the collection application of the system. In particular, the various functions and operations provided by the client platform located on the computing device are shown. FIG. 12 illustrates an example of the collection workflow, FIG. 13 illustrates the media flow of the system and FIG. 14 illustrates a settings process flow of the system.

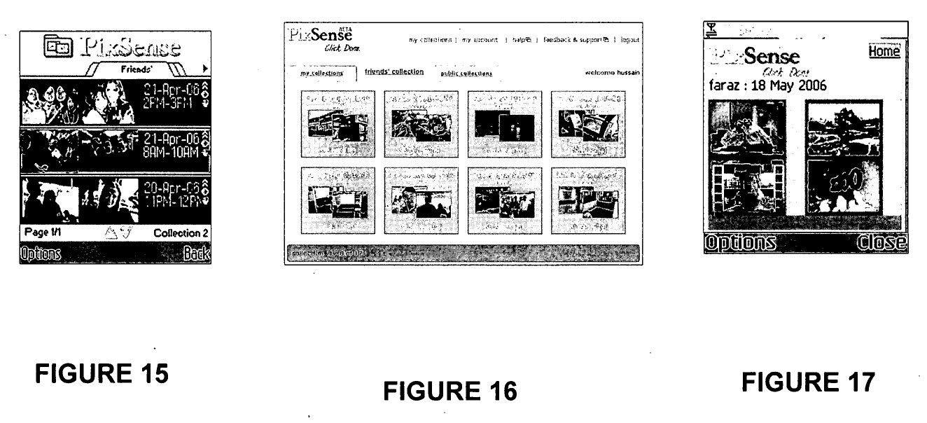

FIGS. 15-17 show examples of the user interface for the gallery on the computing device, the web-based gallery and the WAP page gallery, respectively of the system. In particular, FIG. 15 shows an example of a digital media gallery that is displayed on each computing device of the system. The gallery permits the user of the computing device to review particular digital media or collections of digital media using their computing device. FIG. 16 illustrates the gallery provided to the user when the user accesses the service unit over the web and FIG. 17 illustrates a WAP page version of the gallery (displayed on the computing device). In the examples shown in FIGS. 15-17, the user is viewing the collections of friends of the user.

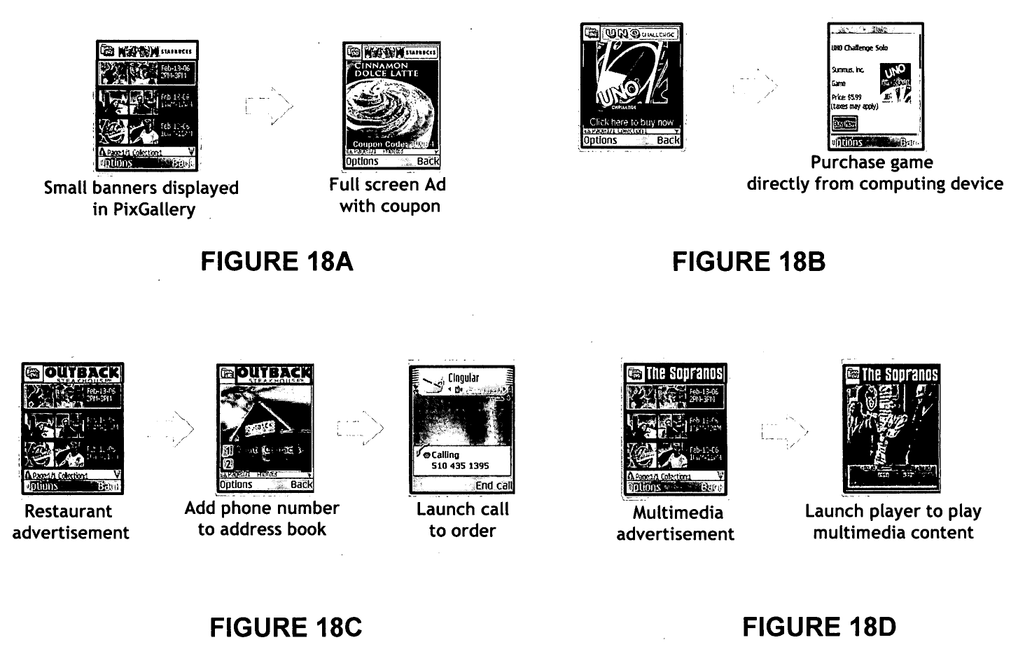

FIGS. 18A-18D illustrate examples of the advertisements provided by the system to the computing device. In particular, the system may generate a small banner advertisement that is displayed in the gallery on the computing device as shown in FIG. 18A that, when clicked on, displays a full screen advertisement with a coupon. Alternatively, the system may display mobile game advertisements on the computing device as shown in FIG. 18B and, when the user clicks on the advertisement, the user can purchase the game directly from the computing device. Alternatively, the system may generate a banner advertisement wherein clicking on the advertisement allows the user to add the phone number of the displayed product/service (a restaurant in this example) into his/her address book and then launch a call to the service as shown in FIG. 18C. The system may also generate a multimedia advertisement as shown in FIG. 18D and, when the user clicks on the advertisement, launch a media player to play the multimedia content.

While the foregoing has been with reference to a particular embodiment of the invention, it will be appreciated by those skilled in the art that changes in this embodiment may be made without departing from the principles and spirit of the invention, the scope of which is defined by the appended claims.

1. A computing device for use in a digital media lifecycle management system that interacts with a service unit having a computing device storage location, comprising:
a processing unit;
a memory containing a plurality of pieces of digital media;
a digital media capturing device that captures a piece of digital media and stores the piece of digital media in the memory; and
a media application executed by the processing unit, the media application further comprising a memory manager module that manages the pieces of digital media stored in the memory, a media display module that displays a gallery containing the pieces of digital media contained in the memory, and a data transport module that is capable of uploading the pieces of digital media contained in the memory automatically to a computing device storage location on a service unit remote from the computing device.

2. The computing device of claim 1, wherein the digital media capturing device further comprises a digital camera integrated into the computing device and wherein each piece of digital media further comprises a digital image generated by the digital camera.

3. The computing device of claim 1, wherein each piece of digital media further comprises a digital photograph, a piece of digital audio or a piece of digital video.

4. The computing device of claim 1, wherein the memory manager module further comprises a module that generates a thumbnail of each piece of digital media wherein the thumbnail uses less memory space than the piece of digital media and discards the piece of media from the memory once the piece of media is uploaded to the service unit.

5. The computing device of claim 4, wherein the memory manager module further comprises a content compression module that compresses each piece of digital media.

6. The computing device of claim 1, wherein the computing device further comprises a mobile phone device, a cellular phone device, a portable email device, a smartphone device or a PocketPC device.

7. The computing device of claim 1, wherein the media application further comprises a content categorization module that permits the user to associate one or more tags with each piece of digital media.

8. The computing device of claim 1, wherein the media application further comprises an advertisement delivery module that delivers an advertisement to the user of the computing device while viewing a piece of digital media and that associates an advertisement with each piece of digital media stored on the computing device.

9. A service unit that is part of a content lifecycle management system that interacts with a plurality of computing device that each capture pieces of content, the service unit comprising:
a processing unit;
a storage unit;
one or more service unit modules that are executed by the processing unit of the service unit; and
the one or more modules further comprising a communications module that receives one or more pieces of content from each computing device; a content archiving module that stores the one or more pieces of content for a particular computing device into a storage location for the particular computing device in the storage unit, a content enhancement module that enhances the perceptual quality of the pieces of content and a content analysis module that analyzes the pieces of content received by the communications module to generate metadata associated with the content and to categorize the pieces of content.

10. The service unit of claim 9 further comprising a gallery module that displays the pieces of content associated with a particular computing device.

11. The service unit of claim 9, wherein the content enhancement module further comprises one or more lines of computer code executed by the processing unit that implement a method for enhancing content captured on a particular computing device based on a set of characteristics of the particular computing device and a method for enhancing a piece of content based on a set of user tags associated with the piece of content.

12. The service unit of claim 9, wherein the one or more modules further comprises a content processing module that processes each piece of content received from each computing device, the content processing module further comprises a transcoding module that converts a format of the piece of content into a different format, a content manipulation module that manipulates a characteristic of the piece of content and a copyright management module that protects each piece of content from unauthorized copying.

13. The service unit of claim 9, wherein the one or more modules further comprises an advertisement module that delivers an advertisement to a computing device.

14. The service unit of claim 9, wherein each piece of content further comprises an image, a piece of digital audio or a piece of digital video.

15. The service unit of claim 13, wherein the advertisement further comprises an advertisement having directions provided to the computing device based on a location of the computing device.

16. The service unit of claim 13, wherein the advertisement further comprises an advertisement having a bar code coupon that is readable by a bar code scanner scanning the screen of the computing device.

17. The service unit of claim 9, wherein the service unit further comprises one or more server computers each having a processing unit that host the one or more modules wherein the one or more modules are executed by the processing units of the one or more server computers, wherein the one or more server computers further comprises one or more applications servers, one or more data storage servers and one or more database servers.

18. The service unit of claim 17, wherein each database server further comprises a MySQL database server.

19. A method for managing the lifecycle of a piece of digital media using one or more computing device wherein each computing device has a processing unit, a memory containing a plurality of pieces of digital media and a digital media capturing device that captures a piece of digital media and stores the piece of digital media in the memory and a service unit that has a processing unit; a storage unit and one or more service unit modules that are executed by the processing unit of the service unit, the method comprising:
managing the pieces of digital media stored in the memory of the computing device;
displaying a gallery containing the pieces of digital media contained in the memory, and
automatically uploading the pieces of digital media contained in the memory of the computing device to a computing device storage location on a service unit remote from the computing device.

20. The method of claim 19 further comprising capturing, on each computing device, a digital image generated by a digital camera integrated into the computing device.

21. The method of claim 19, wherein each piece of digital media further comprises a digital photograph, a piece of digital audio or a piece of digital video.

22. The method of claim 19, wherein managing the piece of digital media further comprises generating a thumbnail of each piece of digital media wherein the thumbnail uses less memory space than the piece of digital media and discarding the piece of media from the memory once the piece of media is uploaded to the service unit.

23. The method of claim 22, wherein managing the piece of digital media further comprises compressing each piece of digital media.

24. The method of claim 19 further comprising categorizing, on each computing device, the pieces of digital media wherein the categorization further comprises associating, by the user of the computing device, one or more tags with each piece of digital media.

25. The method of claim 19 further comprising associating an advertisement with each piece of digital media stored on the computing device and delivering an advertisement to the user of the computing device while viewing a piece of digital media.

26. A method for managing the lifecycle of a piece of digital media using one or more computing device wherein each computing device has a processing unit, a memory containing a plurality of pieces of digital media and a digital media capturing device that captures a piece of digital media and stores the piece of digital media in the memory and a service unit that has a processing unit; a storage unit and one or more service unit modules that are executed by the processing unit of the service unit, the method comprising:
receiving one or more pieces of content from each computing device;
storing the one or more pieces of content from a particular computing device in a storage location for the particular computing device in the storage unit of the service unit;
enhancing a perceptual quality of the pieces of content; and
analyzing each pieces of content stored in the storage unit to generate metadata associated with each piece of content and to categorize each piece of content.

27. The method of claim 26 further comprising displaying, in a gallery module, the pieces of content associated with a particular computing device.

28. The method of claim 26, wherein enhancing a perceptual quality of the pieces of content further comprises enhancing content captured on a particular computing device based on a set of characteristics of the particular computing device and enhancing a piece of content based on a set of user tags associated with the piece of content.

29. The method of claim 26 further comprising converting, using a transcoder module, a format of the piece of content into a different format, manipulating a characteristic of the piece of content and protecting each piece of content from unauthorized copying.

30. The method of claim 26 further comprising delivering an advertisement to each computing device.

31. The method of claim 26, wherein each piece of content further comprises an image, a piece of digital audio or a piece of digital video.

32. The method of claim 30, wherein the advertisement further comprises an advertisement having directions provided to the computing device based on a location of the computing device.

33. The method of claim 30, wherein the advertisement further comprises an advertisement having a bar code coupon that is readable by a bar code scanner scanning the screen of the computing device.
